(19) United States
(12) Patent Application Publication
(10) Pub. No.: US 2015/0189256 A1
(43) Pub. Date: Jul. 2, 2015

(54) AUTOSTEREOSCOPIC MULTI-LAYER DISPLAY AND CONTROL APPROACHES

(71) Applicant: Christian Stroetmann, Moers (DE)

(72) Inventor: Christian Stroetmann, Moers (DE)

(21) Appl. No.: 14/570,716

(22) Filed: Dec. 15, 2014

(30) Foreign Application Priority Data
Dec. 16, 2013 (DE) 20-2013-011-003.1
Dec. 29, 2013 (DE) 20-2013-011-490.8

(51) Int. Cl. H04N 13/04; G06F 3/01

(52) U.S. Cl. CPC H04N 13/0402; G06F 3/011

(57) ABSTRACT

An autostereoscopic multi-layer display device can reduce the amount of computing, processing, and transferring of data in relation with displaying a three-dimensional scene on the device and with creating, maintaining, and improving the perception of depth by providing a mechanism to control the display in correspondence with the movement of a user's feature and to reduce the negative effects of motion. In one example, a user can look on the display from different directions in one dimension without loosing the perception of depth conveyed by the device. If an autostereoscopic multi-layer display displaying the scene is able to detect the position and motion of a user with respect to the device, the control system of the device can update the viewpoint and viewing angle of a virtual camera of the rendering pipeline in response to the users's changed viewpoint or/and viewing angle on the displayed scene with respect to the device. Motion in one or more axes can be used to control the device as discussed herein.

### CROSS-REFERENCE TO RELATED APPLICATION

This application claims the benefit of the German Utility Model Application No. 20-2013-011-003.1, filed Dec. 16, 2013, and entitled “Autostereoskopische Anzeige, die mindestens zwei individuell steuerbare, aktive Anzeigen als Schichten und einen berührungslosen Aufnehmer hat”, and the German Utility Model Application No. 20-2013-011-490.8, filed Dec. 29, 2013, and entitled “Autostereoskopische Anzeige, die einen berührungslosen, optischen oder akustischen Aufnehmer und ein automatisches Regel-/Steuerungssystem besitzt, das die Anzeige durch den berührungslosen Aufnehmer steuert”, which are hereby incorporated by reference in their entirety.

### BACKGROUND

1. Field of the Disclosure

The present application relates to autostereoscopic display devices.

2. Description of the Related Art

People are using display devices to view three-dimensional scenes. As the variety of ways to display three-dimensional scenes on display devices increases, so increases the desire to view three-dimensional scenes on autostereoscopic display devices that need no additional resources like special headgear or glasses on the part of the viewer. One such autostereoscopic display device technology involves using multiple display screen layers, that are stacked on each other and together display a three-dimensional scene in such a way, that a user, when viewing the scene, is experiencing a perception of depth respectively a spatial visual effect.

Unfortunately, such autostereoscopic multi-layer display devices either display a scene only in such a way that a user must look on the display from a specific viewpoint, which lies in an appropriate range of distances and in a specific viewing angle that lies in an appropriate range of angles, as it is the case with autostereoscopic multi-layer display devices based on the parallax barrier method that also reduces the resolution, or they display a scene from several viewpoints and related viewing angles simultaneously, which results in very time intensive computations, processing operations, and transfers of large amounts of data that includes all simultaneously displayed viewpoints and viewing angles on the scene, as it is the case with autostereoscopic multi-layer display devices based on methods, such as the tomographic image synthesis method, the content-adaptive parallax barrier method, and the compressive light field method, which are well known in the art and will not be discussed herein in detail.

A solution to these different problems, that is independent from a specific position with respect to an autostereoscopic multi-layer display device and provides a higher resolution on the one hand and at the same time is less processor and time intensive on the other hand, can involve tracking a feature of the user to determine a user's actual viewpoint and viewing angle on a displayed scene and the user's position with respect to an autostereoscopic multi-layer display device, so that a method, such as the tomographic image synthesis method, the content-adaptive parallax barrier method, and the compressive light field method, only needs to compute, process, and transfer the reduced amount of data related with this actual viewpoint and viewing angle, and position of the user. The invention also offers further optimization of the applied algorithms of these methods on the base of their mathematical frameworks, which are obvious for one of ordinary skill in the art and will not be discussed herein.

### BRIEF SUMMARY

The presently disclosed apparatus and approaches relate to an autostereoscopic multi-layer display device that can reduce the amount of computing, processing, and transferring of data in relation with displaying a three-dimensional scene on the display device and with creating, maintaining, and improving the perception of depth by providing a mechanism to control the display device in correspondence with the movement of a user's feature and to reduce the negative effects of motion. In one example, a user can look on the display device from different directions in one dimension without loosing the perception of depth conveyed by the device. If an autostereoscopic multi-layer display device displaying the scene is able to detect the position and motion of a user with respect to the device, the control system of the display device can update the viewpoint and viewing angle of a virtual camera of the rendering pipeline in response to the users's changed viewpoint or/and viewing angle on the displayed scene with respect to the device. Motion in one or more axes can be used to control the display device as discussed herein.

Interestingly, movement and gesture recognition approaches, as well as navigation approaches used for multi-dimensional input, as described in the U.S. Pat. No. 8,788,977, issued Jul. 22, 2014, and entitled “Movement Recognition as Input Mechanism”, the U.S. Pat. No. 8,891,868, issued Nov. 18, 2014, and entitled “Recognizing gestures captured by video”, and the U.S. patent publication No. 2013/0222246, publicated Aug. 29, 2013 and entitled “Navigation Approaches for Multi-Dimensional Input”, which are hereby incorporated herein by reference, can be applied advantageously. In this relation it has to be understood, however, that these recognition and navigation approaches are related with the software related parts of a computing device, specifically with a graphics user interface (GUI) of an operating system (OS) running on a computing device and software applications running on top of the OS. In contrast, the disclosed invention is related with the hardware related parts of a device, but does not exclude the use of such software related recognition and navigation approaches.

Other systems, methods, features and advantages, objects, and features of the disclosure will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed

### BRIEF DESCRIPTION OF THE DRAWINGS

Various embodiments in accordance with the present disclosure will be described with reference to the drawings, in which:

FIG. 1 illustrates an example configuration of basic components of an autostereoscopic multi-layer display;

FIG. 2 illustrates an example autostereoscopic multi-layer display that can be used in accordance with various embodiments;

FIG. 3 illustrates a cross-sectional view showing a section of an autostereoscopic multi-layer display device taken along a line A-A in FIG. 2 in accordance with various embodiments;

FIG. 4 illustrates an example configuration of components of an autostereoscopic multi-layer display such as that illustrated in FIG. 7;

FIG. 5 illustrates an example of a user providing motion-based input to an autostereoscopic multi-layer display in accordance with various embodiments;

FIGS. 6(a) and 6(b) illustrate an example process whereby a user changes the position with respect to an autostereoscopic multi-layer display and provides motion along a single dimension in order to change the viewpoint and the viewing angle on a three-dimensional scene in accordance with various embodiments;

FIGS. 7(a), 7(b), and 7(c) respectively illustrate a camera-based approach for determining a location of a feature that can be used in accordance with various embodiments; and

FIG. 8 illustrates an example process for accepting input along an appropriate number of directions that can be utilized in accordance with various embodiments.

### DETAILED DESCRIPTION OF THE INVENTION

Systems and methods in accordance with various embodiments of the present disclosure may overcome one or more of the aforementioned and other deficiencies experienced in conventional approaches to providing output of an autosterescopic multi-layer display to a user. In particular, various embodiments enable the construction of an autosterescopic multi-layer display device, or a computing device featuring such an autosterescopic multi-layer display device, capable to determine a position of a user's feature using motions performed at a distance from the device and to provide output to a user in response to the motions' information captured by one or more sensors of the device. In at least some embodiments, a user is able to perform motions within a range of one or more sensors of an autosterescopic multi-layer display device. The sensors can capture information that can be analyzed to locate and track at least one moved feature of the user. The autosterescopic multi-layer display device can utilize a recognized position and motion to perform the viewing transformation of a rendering pipeline in correspondence with the determined position of the feature and the changed viewpoint and viewing angle of the user on a displayed three-dimensional scene with respect to the autostereoscopic display device; perform the window-to-viewport transformation; and generate and display the updated two-dimensional raster representations of the three-dimensional scene on the display screen layers of the autosterescopic multi-layer display device.

Approaches in accordance with various embodiments can create, maintain, and improve the depth perception conveyed by autostereoscopic output by responding on changes due to natural human motion and other such factors. Motions can often be performed in one, two, or three dimensions. Various embodiments can attempt to determine changes of position, and in this way changes of a user's viewpoint and viewing angle on a displayed three-dimensional scene that are performed using motion along one axis or direction with respect to the display device. In response to these changes of the viewpoint and the viewing angle the display device can transform the presentation of the scene. Such approaches can be used for any dimension, axis, plane, direction, or combination thereof, for any appropriate purpose as discussed and suggested elsewhere herein. Such approaches also can be utilized where the device is moved relative to a user feature.

Various other applications, processes, and uses are presented below with respect to the various embodiments.

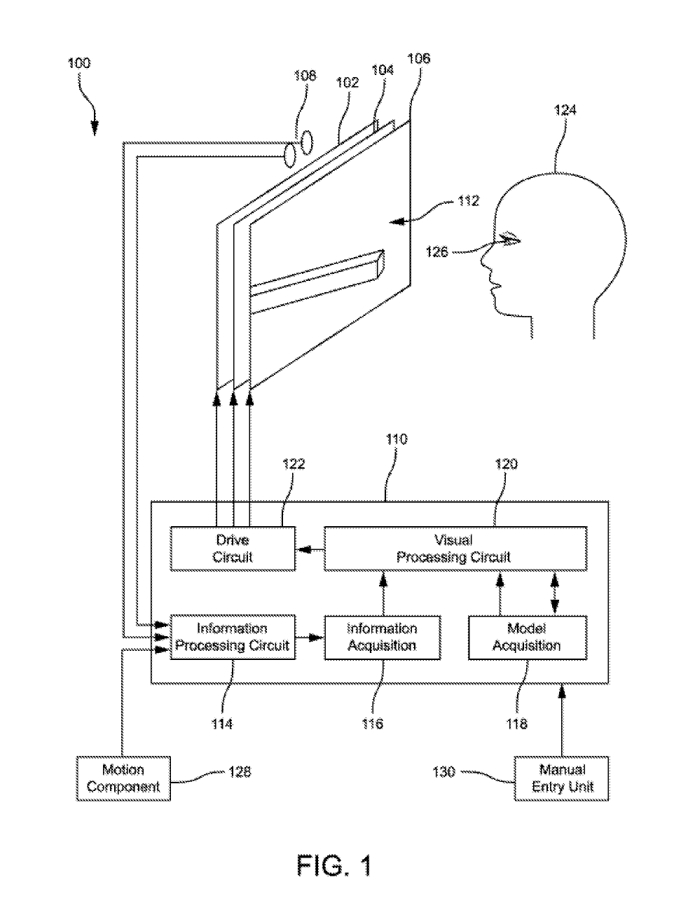

In order to provide various functionality described herein, FIG. 1 illustrates an example set of basic components of an autostereoscopic multi-layer display device 100 without a device casing, discussed elsewhere herein in relation with a computing device featuring such a display, for better understanding of illustration. In this example, the autostereoscopic multi-layer display device 100 features as components three display screen layers 102, 104, 106, a stereoscopic camera 108 as information capture element, and a control system 110, to display a three-dimensional scene 112 on the display screen layers to a user attempting to create, maintain, and improve a perception of depth.

The control system 110 includes an information processing circuit 114, an information acquisition component 116, a model acquisition component 118, a type of visual processing circuit 120, such as a programmable graphics processing unit (GPU) for example, and a drive circuit 126.

As would be apparent to one of ordinary skill in the art, the display device can include many types of display screen layer elements such as a touch screen, electronic ink (e-ink) display device, interferometric modulator display (IMOD) device, liquid crystal display (LCD) device, organic light emitting diode (OLED) display device, or quantum dot based light emitting diode (QLED) display device.

In at least some embodiments, at least one display screen layer provides for touch or swipe-based input using, for example, capacitive or resistive touch technology.

In the case of a camera, a sensor information capture element can include, or be based at least in part upon any appropriate technology, such as a CCD or CMOS image capture element having a determined resolution, focal range, viewable area, and capture rate. Such image capture elements can also include at least one IR sensor or detector operable to capture image information for use in determining motions of the user. It should be understood, however, that there can be fewer or additional elements of similar or alternative types in other embodiments, and that there can be combinations of display screen layer elements and contactless sensors, and other such elements used with various devices.

In this example, the stereoscopic camera 108 can track a feature of the user, such as the user's head 124, or eye 126, as discussed elsewhere herein, and provide the captured sensor information to the information processing circuit 114 of the control system 110. The information processing circuit determines the location and movement of the user's feature with respect to the display device as discussed elsewhere herein, and provides the determined information about the position and motion of the user's feature to the information acquisition component 116 of the control system.

On the basis of the three-dimensional model of the scene and additional related information provided by the model acquisition component 118, the position and motion information provided by the information acquisition component 116, and/or the applied method for creating a perception of depth, the visual processing circuit 120 performs the viewing transformation, including camera transformation and projection transformation, in correspondence with the change of the user's viewpoint and viewing angle on the displayed three-dimensional scene 112, performs the window-to-viewport transformation, synthesizes the two-dimensional raster representations for each single display screen layer 102, 104, 106 of the autostereoscopic multi-layer display device, and provides the raster representations to the drive circuit 122. The drive circuit transfers the two-dimensional raster representations of the scene to the display screen layers. Methods to creating a perception of depth, such may include tomographic image synthesis, content-adaptive parallax barrier, and compressive light field methods, are well known in the art and will not be discussed herein in detail.

The example display device can also include at least one motion component 128, such as an electronic gyroscope, kinds of inertial sensors, or an inertial measurement unit, connected to the information processing circuit 114 of the control system 110 to determine motion of the display device for assistance in location and movement information or/and user input determination, and a manual entry unit 130 to adjust the degree of depth perception created by the visual processing circuit 124 of the control system 110.

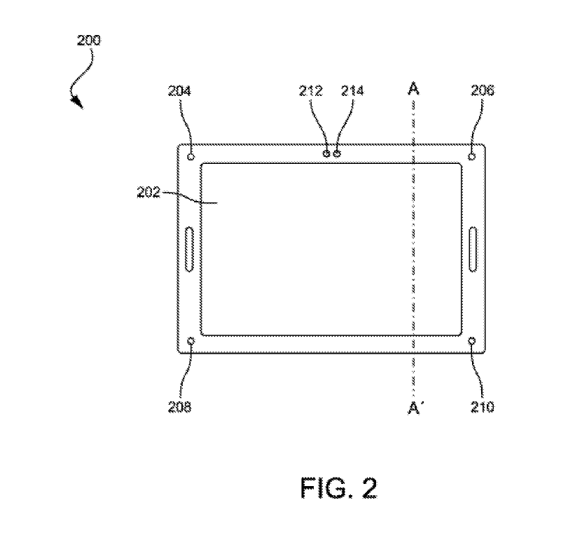

FIG. 2 illustrates an example device with an autostereoscopic multi-layer display 200 that can be used to perform methods in accordance with various embodiments discussed and suggested herein. In this example, the device has four information capture elements 204, 206, 208, 210 positioned at various locations on the same side of the device as the display screen layer elements 202, enabling the display device to capture sensor information about a user of the device during typical operation where the user is at least partially in front of the autostereoscopic multi-layer display device. In this example, each capture element is a camera capable of capturing image information over a visible or/and infrared (IR) spectrum, and in at least some embodiments can select between visible and IR operational modes. It should be understood, however, that there can be fewer or additional elements of similar or alternative types in other embodiments, and that there can be combinations of cameras, infrared detectors, sensors, and other such elements used with various devices.

In this example, at least one light sensor 214 is included that can be used to determine an amount of light in a general direction of objects to be captured, and at least one illumination element 212, such as a white light emitting diode (LED) or infrared (IR) emitter, as discussed elsewhere herein, for providing illumination in a particular range of directions when, for example, there is insufficient ambient light determined by the light sensor or reflected IR radiation is to be captured. The device can have a material and/or components that enable a user to provide input to the device by applying pressure at one or more locations. A device casing can also include touch-sensitive material that enables a user to provide input by sliding a finger or other object along a portion of the casing. Various other elements and combinations of elements can be used as well within the scope of the various embodiments as should be apparent in light of the teachings and suggestions contained herein.

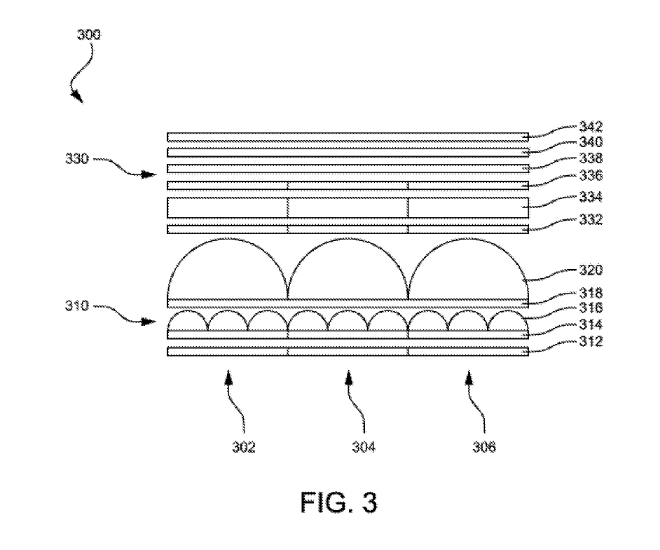

FIG. 3 illustrates a cross-sectional view of a section of an autostereoscopic multi-layer display device, such as the device 200 described with respect to FIG. 2, taken along a line A-A in FIG. 2 showing an embodiment, which has display screen layers with arrays of optical lenses.

Referring to FIG. 3, a single pixel 300 with a red subpixel 302, a green subpixel 304, and a blue subpixel 306 of an autostereoscopic two-layer display device is illustrated as a layer model, that in this example includes a liquid crystal display (LCD) device 330 stacked on a quantum dot light-emitting diode display (QLEDD) device, which functions as a directional backlight device 310. The layer with the directional backlight 310 includes the sublayers with field-effect transistors (FETs) 312 of the directional backlight device, quantum dot light-emitting diode (QLED) devices 314, array of nanolenses 316, which serves as a light diffusors for an area illumination, polarizer 318, and array of microlenses 320.

The layer with the LCD device 330 includes the sublayers with thin-film transistors (TFTs) 332, liquid crystals 334, color filter 336, and polarizer 338. In addition, the autostereoscopic two-layer display device has sublayers with touch-sensitive sensor 340, and encapsulation substrate with scratch-resistant coating 342.

The directional backlight device 310 is based on the integral imaging method for multiscopic display devices, that can be viewed from multiple viewpoints by one or more users simultaneously on the one hand and on the other hand is well known in the art and will not be discussed herein in detail. As a result, the perception of depth can be improved considerably with the use of an directional backlight device 310 in relation with respect to various embodiments.

Furthermore, it is to be understood that any person skilled in the art should be able to construct a similar autostereoscopic multi-layer display device, for example by obmitting one of the layers with an array of optical lenses, by substituting the nanolenses with nanogrooves as light diffusors, or/and by applying other ways of construction.

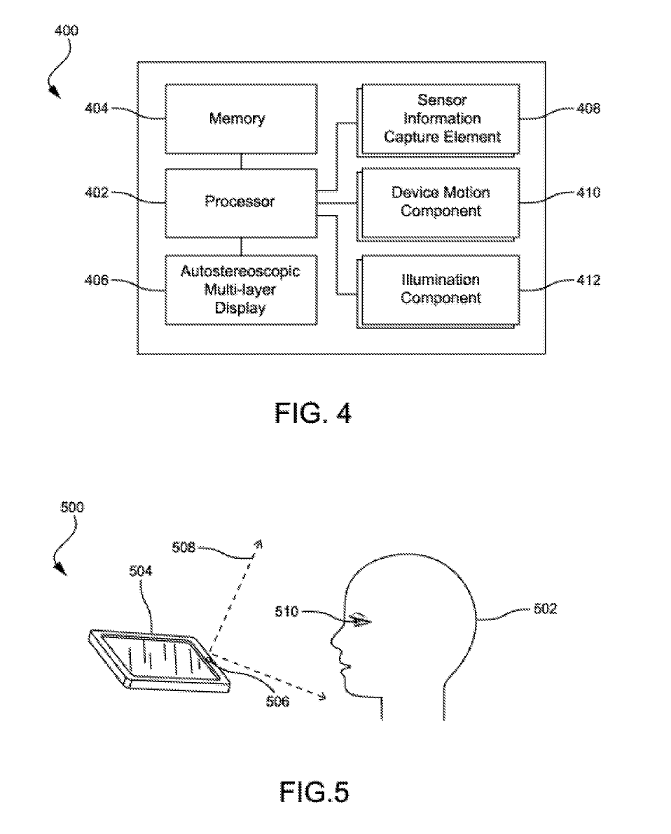

In order to provide various functionality described herein, FIG. 4 illustrates an example set of basic components of a computing device 400 with an autostereoscopic multi-layer display device, such as the device 200 described with respect to FIG. 2. A similar computing device can be found, for example, in U.S. patent publication No. 2013/0222246, publicated Aug. 29, 2013 and entitled “Navigation Approaches for Multi-Dimensional Input”, which is already incorporated herein by reference.

In this example, the computing device includes at least one central processor 402 for executing instructions that can be stored in at least one memory device or element 404. As would be apparent to one of ordinary skill in the art, the computing device can include many types of memory, data storage or non-transitory computer-readable storage media, such as a first data storage for program instructions for execution by the processor 402, the same or separate storage can be used for images or data, a removable storage memory can be available for sharing information with other computing devices, etc. The computing device also includes an autostereoscopic multi-layer display device 406, with some type of display screen layer elements, as discussed elsewhere herein, and also might convey information via other means, such as through audio speakers, or vibrators.

As discussed, the computing device with an autostereoscopic multi-layer display device 406 in many embodiments includes at least one sensor information capture element 408, such as one or more cameras that are able to image a user of the computing device. The example computing device includes at least one motion component 410, such as one or more electronic gyroscopes or/and inertial sensors discussed elsewhere herein, used to determine motion of the computing device for assistance in information or/and input determination for controlling the hardware based functions, specifically the autostereoscopic multi-layer display device 406, and also the software based functions. The computing device also can include at least one illumination element 412, as may include one or more light sources (e.g., white light LEDs, IR emitters, or flashlamps) for providing illumination and/or one or more light sensors or detectors for detecting ambient light or intensity, etc.

The example computing device can include at least one additional input device able to receive conventional input from a user. This conventional input can include, for example, a push button, touch pad, touch screen, wheel, joystick, keypad, mouse, trackball, keypad or any other such device or element whereby a user can input a command to the device. These input/output (I/O) devices could even be connected by a wireless infrared or other wireless link, or a wired link as well in some embodiments. In some embodiments, however, such a computing device might not include any buttons at all and might be controlled only through a combination of visual (e.g., gesture) and audio (e.g., spoken) commands such that a user can control the device without having to be in contact with the computing device.

As discussed, various approaches enable an autostereoscopic multi-layer display device to determine a position and track the motion of a user's feature through capturing sensor information and to provide output to a user through the layered display screens of the device. For example, FIG. 5 illustrates an example situation 500 wherein a user 502 is able to provide information about a position of a feature, such as the user's eye 510, to an electronic device with an autostereoscopic multi-layer display device 504 by moving the feature within a range 408 of at least one camera 506 or another sensor of the autostereoscopic multi-layer display device 504.

While the electronic device in this example is a portable computing device with an autostereoscopic multi-layer display device, such as a smart phone, tablet computer, personal data assistant, smart watch, or smart glasses, it should be understood that any appropriate electronic or computing device can take advantage of aspects of the various embodiments, as may include personal computers, smart televisions, video game systems, set top boxes, vehicle dashboards and glass cockpits, and the like. In this example, the computing device with the autostereoscopic multi-layer display device includes a single camera operable to capture images and/or video of the user's eye 510 and analyze the relative position and/or motion of that feature over time to attempt to determine the user's viewpoint and viewing angle on a displayed scene provided by the autostereoscopic multi-layer display device. It should be understood, however, that there can be additional cameras, or alternative sensors or elements in similar or different places with respect to the device in accordance with various embodiments. The image can be analyzed using any appropriate algorithms to recognize and/or locate a feature of interest, as well as to track that feature over time. Examples of feature tracking from captured image information can be found, for example, in U.S. patent application Ser. No. 12/332,049, filed Dec. 10, 2008, and entitled “Movement Recognition as Input Mechanism”, which is already incorporated herein by reference.

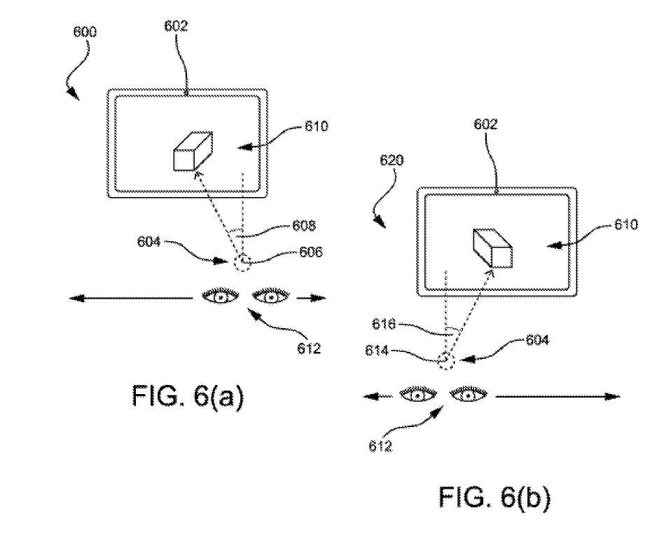

By being able to track the motion of a user's feature with respect to the device, the autostereoscopic multi-layer display can determine the user's changed viewpoint and viewing angle on a three-dimensional scene displayed on the display device and control the device accordingly to convey a perception of depth. For example, in the situations 600 of FIGS. 6(a) and 620 of FIG. 6(b) the user is able to move the user's eyes 612 in a virtual plane with respect to the the autostereoscopic multi-layer display 602, such as in horizontal and vertical directions with respect to the display screen layers of the device, in order to move the viewpoint 606 and change the related viewing angle 608 of a virtual camera 604 on a three-dimensional scene 610 displayed on the device.

The virtual camera's viewpoint can move and its related viewing angle can change with the user's eyes, face, head, or other such feature as that feature moves with respect to the device, in order to enable the autostereoscopic multi-layer display to perform the corresponding transformation of the viewing on the scene without physically contacting the device. In the situation 600 of FIG. 6(a) the user's eyes 612 view from the right side on the autostereoscopic multi-layer display 602 and see the scene 610 presented with the corresponding viewpoint 606 and viewing angle 606 of the virtual camera. In the situation 620 of FIG. 6(b) the user's eyes 612 have another position with respect to the device, view from the left side on the autostereoscopic multi-layer display with a different viewpoint and viewing angle as in situation 610 of FIG. 6(a), and see the scene 610 presented with the corresponding different viewpoint 614 and viewing angle 616 of the virtual camera.

Although two eyes are illustrated in this example, it should be understood that other features like the user's iris, face, or head can be can be used to determine the user's viewpoint and viewing angle and the virtual camera's viewpoint and viewing angle that in general must not be congruent. Furthermore, although two eyes are illustrated near a right and left of the device in this example, it should be understood that terms such as “right” and “left” are used for clarity of explanation and are not intended to require specific orientations unless otherwise stated.

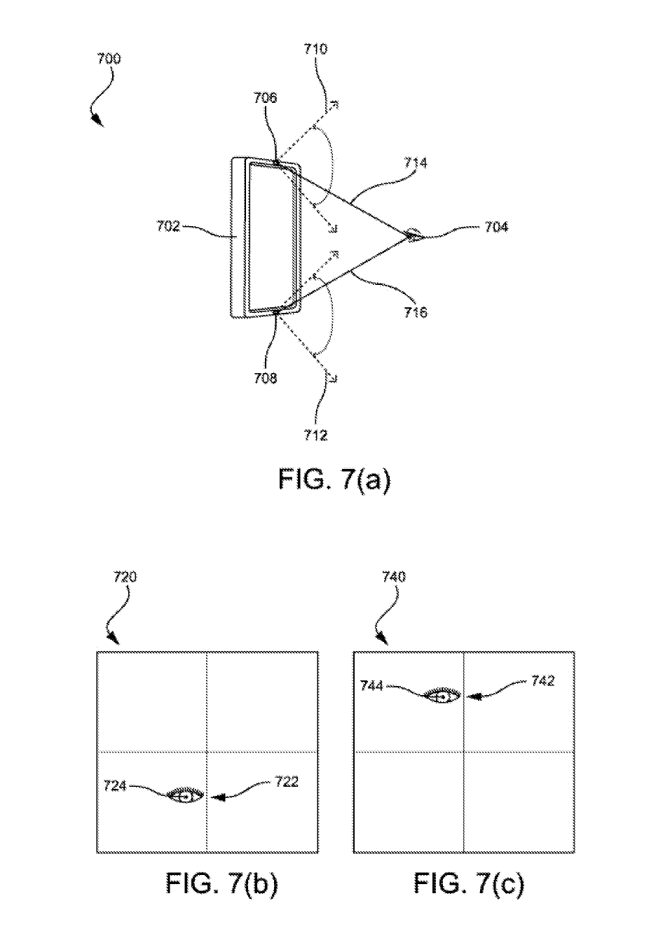

As mentioned, approaches in accordance with various embodiments can capture and analyze image information or other sensor data to determine information such as the relative distance and/or location of a feature of the user. For example, FIGS. 7(a), 7(b), and 7(c) illustrate one example approach to determining a relative direction and/or location of at least one feature of a user that can be utilized in accordance with various embodiments. In this example, information can be provided to an autostereoscopic multi-layer display device 702 by monitoring the position of the user's eye 704 with respect to the device. In some embodiments, a single camera can be used to capture image information including the user's eye, where the relative location can be determined in two dimensions from the position of the eye in the image and the distance determined by the relative size of the eye in the image. In other embodiments, a distance detector, three-dimensional scanner, or other such sensor can be used to provide the distance information. The illustrated autostereoscopic multi-layer display device 702 in this example instead includes at least two different image capture elements 706, 708 positioned on the device with a sufficient separation such that the display device can utilize stereoscopic imaging (or another such approach) to determine a relative position of one or more features with respect to the display device in three dimensions.

Although two cameras are illustrated near a top and bottom of the device in this example, it should be understood that there can be additional or alternative imaging elements of the same or a different type at various other locations on the device within the scope of the various embodiments. The cameras can include full color cameras, infrared cameras, grayscale cameras, and the like as discussed elsewhere herein as well. Further, it should be understood that terms such as “top” and “upper” are used for clarity of explanation and are not intended to require specific orientations unless otherwise stated.

In this example, the upper camera 706 in FIG. 7(a) is able to see the eye 704 of the user as long as that feature is within a field of view 710 of the upper camera 706 and there are no obstructions between the upper camera and those features. If a process executing on the display control system (or otherwise in communication with the display control system) is able to determine information such as the angular field of view of the camera, the zoom level at which the information is currently being captured, and any other such relevant information, the process can determine an approximate direction 714 of the eye with respect to the upper camera. If information is determined based only on relative direction to one camera, the approximate direction 714 can be sufficient to provide the appropriate information, with no need for a second camera or sensor, etc. In some embodiments, methods such as ultrasonic detection, feature size analysis, luminance analysis through active illumination, or other such distance measurement approaches can be used to assist with position determination as well.

In this example, a second camera is used to assist with location and movement determination as well as to enable distance determinations through stereoscopic imaging. The lower camera 708 in FIG. 7(a) is also able to image the eye 704 of the user as long as the feature is at least partially within the field of view 712 of the lower camera 708. Using a similar process to that described above, an appropriate process can analyze the image information captured by the lower camera to determine an approximate direction 716 to the user's eye. The direction can be determined, in at least some embodiments, by looking at a distance from a center (or other) point of the image and comparing that to the angular measure of the field of view of the camera. For example, a feature in the middle of a captured image is likely directly in front of the respective capture element. If the feature is at the very edge of the image, then the feature is likely at a 45 degree angle from a vector orthogonal to the image plane of the capture element. Positions between the edge and the center correspond to intermediate angles as would be apparent to one of ordinary skill in the art, and as known in the art for stereoscopic imaging. Once the direction vectors from at least two image capture elements are determined for a given feature, the intersection point of those vectors can be determined, which corresponds to the approximate relative position in three dimensions of the respective feature.

Further illustrating such an example approach, FIGS. 7(b) and 7(c) illustrate example images 720, 740 that could be captured of the eye using the cameras 706, 708 of FIG. 7(a). In this example, FIG. 7(b) illustrates an example image 720 that could be captured using the upper camera 706 in FIG. 7(a). One or more image analysis algorithms can be used to analyze the image to perform pattern recognition, shape recognition, or another such process to identify a feature of interest, such as the user's iris, eye, face, head, or other such feature. Approaches to identifying a feature in an image, such may include feature detection, facial feature extraction, feature recognition, stereo vision sensing, or radial basis function (RBF) analysis approaches, are well known in the art and will not be discussed herein in detail. Upon identifying the feature, here the user's eye 722, at least one point of interest 724, here the iris of the user's eye, is determined. As discussed above, the display control system of an autostereoscopic multi-layer display device can use the location of this point with information about the camera to determine a relative direction to the eye, but also a relative direction of the gaze of the eye to the device.

A similar approach can be used with the image 740 captured by the lower camera 708 as illustrated in FIG. 7(c), where the eye 742 is located and a direction to the corresponding point 744 determined. As illustrated in FIGS. 7(b) and 7(c), there can be offsets in the relative positions of the features due at least in part to the separation of the cameras. Further, there can be offsets due to the physical locations in three dimensions of the features of interest. By looking for the intersection of the direction vectors to determine the position of the eye and/or the position of the iris and the angle of gaze in three dimensions, a corresponding information can be determined within a determined level of accuracy. If higher accuracy is needed, higher resolution and/or additional elements can be used in various embodiments. Further, any other stereoscopic or similar approach for determining relative positions in three dimensions can be used as well within the scope of the various embodiments. Examples of capturing and analyzing image information can be found, for example, in U.S. patent publication No. 2013/0222246, publicated Aug. 29, 2013 and entitled “Navigation Approaches for Multi-Dimensional Input”, which is already incorporated herein by reference.

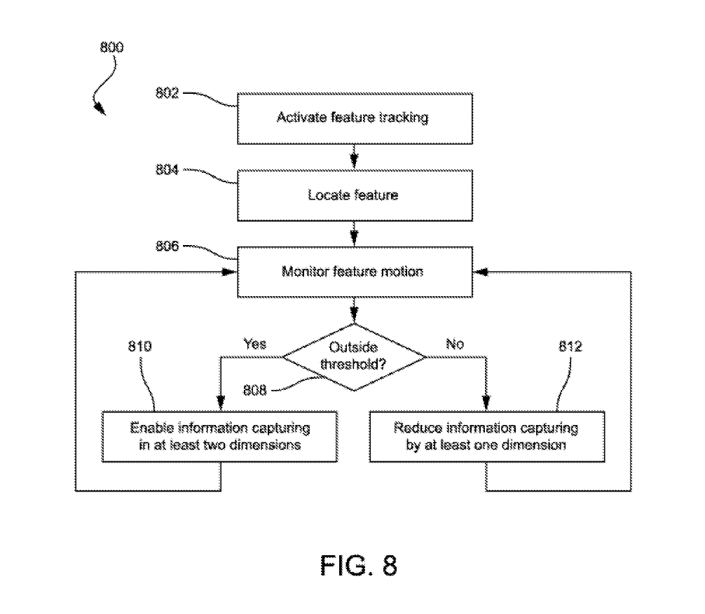

FIG. 8 illustrates an example process 800 for providing input to an autostereoscopic multi-layer display device using information about motion that can be used in accordance with various embodiments. It should be understood that, for any process discussed herein, there can be additional, fewer, or alternative steps performed in similar or alternative orders, or in parallel, within the scope of the various embodiments unless otherwise stated.

In this example, feature tracking is activated 802 on an autostereoscopic multi-layer display device. The tracking can be activated manually, by a user, or automatically in response to an application, activation, startup, or other such action. Further, the feature that the process tracks can be specified or adjusted by a user, provider, or other such entity, and can include any appropriate feature such as an iris, eye, face, head, or other such feature. In at least some embodiments a determination can be made as to whether there is sufficient lighting for image capture and analysis, such as by using a light sensor or analyzing the intensity of captured image information. In at least some embodiments, a determination that the lighting is not sufficient can cause one or more types of illumination to be activated on the display device. In at least some embodiments, this can include activating one or more white light LEDs positioned to illuminate a feature within the field of view of at least one camera attempting to capture image information. As discussed elsewhere herein, other types of illumination can be used as well, such as infrared (IR) radiation useful in separating a feature in the foreground from objects in the background of an image. Examples of using IR radiation to assist in locating a feature of a user can be found, for example, in U.S. Pat. No. 8,891,868, issued Nov. 18, 2014, and entitled “Recognizing gestures captured by video”, which is already incorporated herein by reference.

During the process, one or more selected sensors can capture information as discussed elsewhere herein. The selected sensors can have ranges that include at least a portion of the region in front of or other specified area of the autostereoscopic multi-layer display information, such that the sensors can capture a feature when interacting with the device. The captured information, which can be a series of still images or a stream of video information in various embodiments, can be analyzed to attempt to determine or locate 804 the relative position of at least one feature to be monitored, such as the relative position of the user's iris of a visible eye or the user's eye of a visible face. As discussed elsewhere herein, various recognition, contour matching, color matching, or other such approaches can be used to identify a feature of interest from the captured sensor information. Once a feature is located and its relative distance determined, the motion of that feature can be monitored 806 over time, such as to determine whether the user is moving fast or slow or/and in a line, plane, or cuboid relative to the display screen.

During the process, at least one threshold or other such measure or criterion can be utilized to determine the number of dimensions for which to accept or determine sensor information. During monitoring of the motion, the display device can determine 808 whether the motion meets, falls within, falls outside, or otherwise reaches or exceeds some threshold with respect to the sensor information to be captured. If the motion is determined to be outside the threshold, the device can enable 810 capturing of information in at least two dimensions. If, in this example, the motion is determined to fall inside the threshold, the capturing of information can be reduced 812 by at least one dimension. This can involve locking or limiting motion in one or more directions in order to improve accuracy of the capturing of information. For certain motions, capturing of sensor information might be effectively constrained to a direction or plane, etc. As the motions change with respect to the threshold(s), the dimensional input can adjust as well.

It should be understood that various other uses can benefit from approaches discussed herein as well. For example, a user might utilize motion input for navigation, gaming, drawing, or other such purposes. When the user makes a certain motion, the display device can effectively lock out one or more directions of input in order to improve the accuracy of the input. Examples of gesture based input provided by a user can be found, for example, in U.S. patent publication No. 2013/0222246, publicated Aug. 29, 2013 and entitled “Navigation Approaches for Multi-Dimensional Input”, which is already incorporated herein by reference.

In addition, other measures can be used to assist in determining when to stop capturing sensor information in one or more directions of movement. For example, speed might be used to attempt to determine when to lock out other axes. In some embodiments, locking only occurs when and where it makes sense or provides an advantage. Certain contexts can be used to determine when to stop capturing sensor information as well, such as when a user is providing any input to an electronic device, that features an autostereoscopic multi-layer display device. In at least some embodiments, an interface might show an icon or other indicator when capturing information is locked such that the user can know how movement will be interpreted by the autostereoscopic multi-layer display device.

As mentioned, various approaches can be used to attempt to locate and track specific features over time. One such approach utilizes ambient-light imaging with a digital camera (still or video) to capture images for analysis.

In at least some instances, however, ambient light images can include information for a number of different objects and thus can be very processor and time intensive to analyze. For example, an image analysis algorithm might have to differentiate the head from various other objects in an image, and would have to identify the head as a head, regardless of the head's orientation. Such an approach can require shape or contour matching, for example, which can still be relatively processing intensive. A less processing intensive approach can involve separating the head from the background before analysis.

In at least some embodiments, a light emitting diode (LED) or other source of illumination can be triggered to produce illumination over a short period of time in which an image capture element is going to be capturing image information. The LED can illuminate a feature relatively close to the device much more than other elements further away, such that a background portion of the image can be substantially dark (or otherwise, depending on the implementation). In one example, an LED or other source of illumination is activated (e.g., flashed or strobed) during a time of image capture of at least one camera or sensor. If the user's head is relatively close to the device the head will appear relatively bright in the image. Accordingly, the background images will appear relatively, if not almost entirely, dark. This approach can be particularly beneficial for infrared (IR) imaging in at least some embodiments. Such an image can be much easier to analyze, as the head has been effectively separated out from the background, and thus can be easier to track through the various images. Further, there is a smaller portion of the image to analyze to attempt to determine relevant features for tracking. In embodiments where the detection time is short, there will be relatively little power drained by flashing the LED in at least some embodiments, even though the LED itself might be relatively power hungry per unit time.

Such an approach can work both in bright or dark conditions. A light sensor can be used in at least some embodiments to determine when illumination is needed due at least in part to lighting concerns. In other embodiments, a device might look at factors such as the amount of time needed to process images under current conditions to determine when to pulse or strobe the LED. In still other embodiments, the device might utilize the pulsed lighting when there is at least a minimum amount of charge remaining on the battery, after which the LED might not fire unless directed by the user or an application, etc. In some embodiments, the amount of power needed to illuminate and capture information using the motion sensor with a short detection time can be less than the amount of power needed to capture an ambient light image with a rolling shutter camera without illumination.

In some embodiments, an autostereoscopic multi-layer display device might utilize one or more motion-determining elements, such as an electronic gyroscope, kinds of inertial sensors, or an inertial measurement unit to attempt to assist with location determinations. For example, a rotation of a device can cause a rapid shift in objects represented in a captured data, which might be faster than a position tracking algorithm can process. By determining movements of the device during sensor data capture, effects of the device movement can be removed to provide more accurate three-dimensional position information for the tracked user features.

The specification and drawings are, accordingly, to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, the scope of the present disclosure shall be determined only by the appended claims and their equivalents. In addition, variations and modifications in the component parts and/or arrangements, alternative uses must be regarded as included in the appended claims.

1. An autostereoscopic display device, comprising:
at least two individually controllable, active display screen layers;
at least one contactless sensor; and
an integrated circuit based control system capable to perform a set of actions, enabling the autostereoscopic display to:
display a three-dimensional scene by the individually controllable, active display screen layers of the autostereoscopic display;
capture sensor information using the contactless sensor of the autostereoscopic multi-layer display;
determine, from the captured sensor information, a position of a feature of a user with respect to the autostereoscopic multi-layer display, the position being determined in at least one dimension;
perform a viewing transformation of the rendering pipeline in correspondence with the determined position of the feature and the changed viewpoint or/and viewing angle of the user on the displayed three-dimensional scene with respect to the autostereoscopic multi-layer display;
perform a window-to-viewport transformation; and
display updated two-dimensional raster representations of the three-dimensional scene on the display screen layers.

2. The autostereoscopic display device of claim 1, wherein
the feature is one of an iris, an eye, a face, or a head of the user.

3. The autostereoscopic display device of claim 1, wherein
the position of the feature is capable of being determined in two dimensions, and
changing the viewpoint and the viewing angle data in one or two dimensions.

4. The autostereoscopic display device of claim 1, wherein
the position of the feature is capable of being determined in three dimensions, and
changing the viewpoint and the viewing angle data in one, two, or three dimensions.

5. The autostereoscopic display device of claim 1, wherein
the contactless sensor is a two-dimensional optical sensor, and
the captured sensor information is a two-dimensional image.

6. The autostereoscopic display device of claim 1, wherein
the contactless sensor is a three-dimensional optical sensor, and
the captured sensor information is a three-dimensional image.

7. The autostereoscopic display device of claim 6, wherein
the three-dimensional optical sensor is a stereoscopic camera.

8. The autostereoscopic display device of claim 6, wherein
the three-dimensional optical sensor is a camera based on the time-of-flight method.

9. The autostereoscopic display device of claim 6, wherein
the three-dimensional optical sensor is a plenoptic camera respectively light-field camera.

10. The autostereoscopic display device of claim 6, wherein
the three-dimensional optical sensor is a camera based on the structured-light method.

11. The autostereoscopic display device of claim 1, wherein
the contactless sensor is a two-dimensional sound transducer respectively microphone, and
the captured sensor information is a two-dimensional sound record.

12. The autostereoscopic display of claim 1, wherein
the contactless sensor is a three-dimensional sound transducer respectively microphone, and
the captured sensor information is a three-dimensional sound record.

13. The autostereoscopic display device of claim 12, wherein
the three-dimensional sound transducer is a stereo microphone.

14. The autostereoscopic display device of claim 12, wherein
the three-dimensional sound transducer is a receiver respectively microphone based on the time-of-flight method.

15. The autostereoscopic display device of claim 12, wherein
the three-dimensional sound transducer is a sound-field receiver respectively wave-field microphone.

16. The autostereoscopic display device of claim 12, wherein
the three-dimensional sound transducer is a receiver respectively microphone based on the structured-sound method.

17. The autostereoscopic display device of claim 1, further comprising:
an additional contactless sensor that is an inertial sensor.

18. The autostereoscopic display device of claim 17, wherein
the additional inertial sensor is an accelerometer, and that
the accelerometer is combined with at least one angular rate sensor to an inertial measurement unit.

19. The autostereoscopic display device of claim 17, wherein
the additional inertial sensor is an accelerometer, and that
the accelerometer is combined with at least one electronic gyroscope to an inertial measurement unit.

20. The autostereoscopic display device of claim 1, further comprising:
an additional touch-sensitive sensor.

21. The autostereoscopic display device of claim 1, wherein
the backlight is of type quantum dot based light emitting diode (QLED).

22. The autostereoscopic display device of claim 1, wherein
the backlight is of type light emitting diode (LED) with a layer of quantum dots.

23. The autostereoscopic display device of claim 1, further comprising:
a layer of nanocrystals respectively quantum dots.

24. The autostereoscopic display device of claim 1, further comprising:
a layer with an array of optical lenses.

25. The autostereoscopic display device of claim 1, further comprising:
a layer with nanostructured grooves.

26. An integrated circuit implemented method enabling control of an autostereoscopic multi-layer display device, comprising:
displaying a three-dimensional scene by at least two individually controllable, active display screen layers of the autostereoscopic display;
capturing information using at least one contactless sensor of the autostereoscopic display;
analyzing the sensor information, using integrated circuits of a control system, to determine a position of a feature of a user with respect to the electronic device;
updating a current viewpoint and viewing angle on the three-dimensional scene of a virtual camera of a rendering pipeline, the virtual camera's viewpoint and viewing angle configured to change in one dimension corresponding to the movement of the feature of the user in a line relative to the display screen, by performing the viewing transformation, including the virtual camera transformation and the projection transformation, and the window-to-viewport transformation of the rendering pipeline in relation with the displayed three-dimensional scene; and
displaying the updated two-dimensional raster representations of the three-dimensional scene on the display screen layers of the autostereoscopic display.

27. The control system implemented method of claim 26, wherein
the position of the feature is being determined in two dimensions, and
the virtual camera's viewpoint and viewing angle on the three-dimensional scene change in two dimensions corresponding to the movement of the feature of the user in a plane relative to the display screen.

28. The integrated circuit implemented method of claim 26, wherein
the position of the feature is being determined in three dimensions, and
the virtual camera's viewpoint and viewing angle on the three-dimensional scene change in three dimensions corresponding to the movement of the feature of the user in a cuboid relative to the display screen.

29. The integrated circuit implemented method of claim 26, wherein
the contactless sensor is a camera, and
the captured sensor information is an image.

30. The integrated circuit implemented method of claim 26, wherein
the contactless sensor is a sensor for a sound wave, and
the captured sensor information is a sound record.

31. The integrated circuit implemented method of claim 26, wherein
the feature is one of an iris, an eye, a face, or a head of the user.

32. The integrated circuit implemented method of claim 26, wherein
changes in the determined position of the feature correspond to movement of at least one of the feature or the autostereoscopic display.

33. The integrated circuit implemented method of claim 26, wherein
determining the position of the feature includes emitting infrared light from the electronic device and detecting infrared light reflected back from the feature.

34. The integrated circuit implemented method of claim 26, further comprising:
determining an amount of light near the autostereoscopic multi-layer display using at least one light sensor; and
activating at least one illumination element of the autostereoscopic multi-layer display when the amount of light is below a minimum light threshold.

35. The integrated circuit implemented method of claim 26, further comprising:
determining an amount of motion of the autostereoscopic multi-layer display using a motion sensor of the autostereoscopic multi-layer display during the determining of the position; and
accounting for the motion of the autostereoscopic multi-layer display when determining changes in the position of the feature.
